(19) United States
(12) Patent Application Publication
(10) Pub. No.: US 2003/0117120 A1
(43) Pub. Date: Jun. 26, 2003

(54) CMOS bandgap refrence with built-in curvature correction

(76) Inventor: Bruce E. Amazeen, Ipswich, MA (US)

Correspondence Address: Randy J. Pritzker, Wolf, Greenfield & Sacks, P.C., Federal Reserve Plaza, 600 Atlantic Avenue, Boston, MA, 02210, US

(21) Appl. No.: 10/034,835

(22) Filed: Dec. 21, 2001

(51) Int. Cl. G05F 3/16

(52) U.S. Cl. 323/313

(57) ABSTRACT

A bandgap reference voltage cell that produces a first-order and a second-order temperature-compensated reference voltage output includes four bipolar transistors. At least one of the four transistors is biased with a current having a different temperature coefficient than that of a current which biases at least the second of the four transistors. The first and second order temperature compensation to the reference voltage is realized within the bandgap cell itself.

### FIELD OF THE INVENTION

The present invention relates generally to a method and circuitry for producing a bandgap reference voltage for use in CMOS integrated circuits. More particularly, the invention relates to a method and circuitry for compensating second order temperature characteristics of bandgap reference voltages due to inherent temperature non-linearities of transistor or diode base-emitter voltages.

### BACKGROUND OF THE INVENTION

The use of CMOS integrated circuit components has increased rapidly in recent years. The demand for more reliable, stronger performing, yet less expensive, CMOS integrated circuit components continues to increase as such components are used in numerous devices in the communications, imaging and high-quality video applications. Integrated circuit component designers and manufacturers require greater accuracy in reference voltages used by such components in order to meet design requirements of devices in the applications mentioned and in a myriad of other emerging applications for such devices.

Voltage references used by such components typically are required to remain substantially constant despite changes in certain parameters. Bandgap reference voltage circuits are well-known and commonly are used to provide reference voltages that are insensitive to temperature variations over a wide temperature range. Often, bandgap reference voltage circuits are designed based on certain temperature-dependent characteristics of a base-emitter voltage, V_{be}, of a bipolar transistor or diode. More specifically, some bandgap reference voltage circuits operate on the principle of compensating for a negative temperature coefficient of a bipolar transistor base-emitter voltage, V_{be}, with a positive temperature coefficient of a thermal voltage. Typically, the negative temperature coefficient of the base-emitter voltage V_{be} is summed with the positive temperature coefficient of a thermal voltage, being appropriately scaled, such that the resulting sum provides a zero temperature coefficient.

Bandgap reference voltage circuits commonly are designed for use in sub-micron CMOS circuits, such as analog-to-digital converters (ADCs), because they can operate at the relatively low supply voltages required by such circuits.

An inherent variation exists for the base-emitter voltage V_{be} of a transistor with respect to temperature. More specifically, the bandgap reference voltage includes a strong second-order term that varies with temperature. In other words, such second-order term causes deviation and drift of the reference voltage with temperature which, in turn, limits the temperature performance of such a reference voltage. While such second-order terms may be relatively small, their impact can prove highly undesirable for many applications. For example, because of the high accuracy required by high-resolution, multi-bit (e.g., sixteen-bit) ADCs over a useful temperature range, the second-order term (or parabolic curvature) inherent in the bandgap reference voltage must be greatly reduced or eliminated. Various methods have been developed to compensate for such curvature. Many of such methods are not suitable for standard CMOS processes because they require low TC (temperature coefficient) resistors or other components typically found in high performance bipolar processes.

One prior art reference voltage circuit approach, consistent with standard CMOS processes, utilizes the difference between base-emitter voltages of two transistors operating at two different temperature coefficient quiescent currents. A part-block, part-schematic diagram of such prior art approach is shown in FIG. 1a.

As shown, the circuit includes a temperature-independent current generator 10, a PTAT (proportional to temperature) current generator 12, a gain block 14, and transistors Q1, Q2 and Q3. In the circuit, the ΔV_{be} (the difference in the base emitted voltages of transistors Q1 and Q2) has a positive and linear temperature coefficient. The base-emitter voltage of V_{be} of transistor Q3 has a negative temperature coefficient. As is typical, when the ΔV_{be} is added to the V_{be}, to produce the output voltage Vref, the temperature coefficient is canceled, as is described with more specificity below.

In the circuit shown in FIG. 1a, the ΔV_{be} generated has a second-order temperature-induced curvature as a result of the currents flowing through transistors Q1 and Q2. Currents I₀ and I_{d} are temperature independent, whereas current Iₜ is proportional to temperature. Temperature independent current generator 10 produces temperature independent currents I₀ and I_{d}. PTAT current generator 12 produces temperature dependent current Iₜ. I₀ plus Iₜ flows through Q2 while I₀ minus Iₜ flows through Q1. As a result, the ΔV_{be} has a second-order curvature that is (when scaled by gain block 14) equal, but opposite to, the second-order curvature in V_{be}. When the two terms are added, the second-order curvature terms cancel one another to produce output reference voltage Vref.

Each of transistors Q1, Q2 and Q3 in the circuit of FIG. 1a may be a substrate PNP transistor commonly available in NWELL CMOS processes. The emitter area of transistor Q1 is A times greater than that of Q2, such that it is operating at a lower current density than that of Q1. Therefore, the base-emitter voltage, V_{be}, of Q2, is less than that of transistor Q1. That difference, ΔV_{be}, has a positive temperature coefficient. The circuit scales ΔV_{be} and adds it to the base-emitter voltage, V_{be}, of transistor Q3, which has a negative temperature coefficient, to achieve an overall zero temperature coefficient output voltage, Vref. Non-linearities are present because the base-emitter voltage, V_{be}, of each of transistors Q1, Q2 and Q3, has a predominantly second order, or parabolic bow, with temperature, that is somewhat dependent on the temperature coefficient of its quiescent current.

Said differently, in a conventional bandgap reference voltage circuit, the currents flowing through transistors Q1 and Q2 are identical, such that their base-emitter voltage V_{be} non-linearities are identical and are canceled in the difference, ΔV_{be}. As a result, the non-linearity in the base-emitter voltage, V_{be}, of transistor Q3, directly affects the output voltage, Vref. By providing a quiescent current to transistor Q1 that has a temperature coefficient different from that of the quiescent current provided to transistor Q2, a residual second-order non-linearity results in the ΔV_{be}. Carefully selecting the values of the transistors, and the currents which flow through them, can result in the second-order non-linearities in the ΔV_{be} canceling, or at least greatly reducing, the second-order non-linearity in the base-emitter voltage V_{be}, of transistor Q3, to produce an output voltage, Vref, with little or no first or second order temperature coefficients. Such is the aim of the circuit of FIG. 1a.

FIG. 1b is a schematic diagram of an available PTAT current generator, shown at block 12 in FIG. 1a. Note that the integrated circuit real estate area consumed by such PTAT current generator is fairly significant, i.e., approximately the area of one conventional bandgap reference voltage circuits, for designs attempting to achieve high accuracy and performance.

FIG. 1c is a schematic diagram of an available temperature independent current generator, shown at block 10 in FIG. 1a. This circuit, due to its many elements, also consumes significant chip real estate.

One more recent prior art approach aimed at eliminating both first-order and second-order temperature coefficients of bandgap reference voltages is described in U.S. Pat. No. 6,255,807, assigned to Texas Instruments Corporation, and entitled “Bandgap Reference Curvature Compensation Circuit.” FIGS. 2 and 3 are taken from the Texas Instruments '807 patent (respectively, FIGS. 2 and 8 of the patent) and illustrate this prior art approach. As shown in the block diagram of FIG. 2, the system proposed includes a conventional bandgap reference circuit BG 202, which provides an output voltage with first-order temperature coefficient correction. A curvature correction voltage is created in CC block 204 and Tln(T) block 208, both external to bandgap reference voltage circuit BG 202. That curvature correction voltage is added to the output of BG 202 by a summing node to produce a first- and second-order temperature compensated reference voltage.

FIG. 3 is a schematic diagram of the Texas Instruments prior art approach. As shown and described, the conventional bandgap reference voltage circuit produces a conventional, first-order corrected, reference voltage output. Transistors Q1 and Q2 are biased with identical positive temperature coefficient currents. Circuitry 804 produces a negative temperature coefficient current to bias transistor Q3, such that its base-emitter voltage, V_{be}, will have a different non-linearity from that of transistor Q2. Circuitry 812 and 816 then adds that non-linearity to the output of the conventional bandgap reference voltage circuit, in order to cancel the non-linearity in its output voltage VBG. Drawbacks with this prior art approach include the significant additional circuitry, external to the bandgap cell, required to achieve the second-order temperature compensation.

### SUMMARY OF THE INVENTION

The present invention is directed to a bandgap reference voltage circuit and method for producing a bandgap reference voltage with first- and second-order temperature coefficient correction. In one embodiment of the invention, the curvature, or second-order, correction is accomplished with circuitry within the bandgap reference voltage circuit itself, thus, providing a relatively simple circuit and method.

More specifically, one embodiment of the invention is directed to a method for providing a temperature-compensated bandgap reference voltage. The method includes providing a bandgap reference voltage cell (circuit) including at least two bipolar elements, and realizing first- and second-order temperature coefficient compensation to the reference voltage within the bandgap cell.

An embodiment of the invention is directed to a method of producing a temperature-compensated reference voltage, comprising steps of: providing a stacked bandgap cell including at least four bipolar elements; and biasing at least a first of the four elements with a first quiescent current and biasing at least a second of the four elements with a second quiescent current; wherein the temperature coefficient of the first quiescent current is different from a temperature coefficient of the second quiescent current.

Another embodiment of the invention is directed to a bandgap cell that produces a first-order and second-order temperature-compensated voltage output comprising at least first and second bipolar elements, wherein the first bipolar element is biased with a first quiescent current, and the second bipolar element is biased with a second quiescent current, a temperature coefficient of the first quiescent current being different from a temperature coefficient of the second quiescent current.

### BRIEF DESCRIPTION OF THE DRAWINGS

FIG. 1a is a part-block, part-schematic diagram of a conventional bandgap reference voltage circuit;

FIG. 1b is a schematic diagram of a conventional temperature dependent current generator circuit used in the bandgap reference voltage circuit of FIG. 1a;

FIG. 1c is a schematic diagram of a temperature independent current generator circuit used in the bandgap reference voltage circuit of FIG. 1a;

FIG. 2 is a block diagram of a prior art approach toward producing a reference voltage with second-order temperature coefficient compensation, from U.S. Pat. No. 6,255,807;

FIG. 3 is a schematic diagram of the prior art approach shown in block diagram form in FIG. 2;

FIG. 4 is a schematic diagram of a bandgap cell having a stacked structure;

Each of FIGS. 5a, 5b and 5c is a schematic diagram of a stacked bandgap cell having second-order curvature correction using a slightly different approach;

FIG. 6 is a circuit diagram of one embodiment of a second-order curvature-corrected stacked bandgap cell; and

FIG. 7 is a schematic diagram of another embodiment of a second-order curvature-corrected stacked bandgap cell.

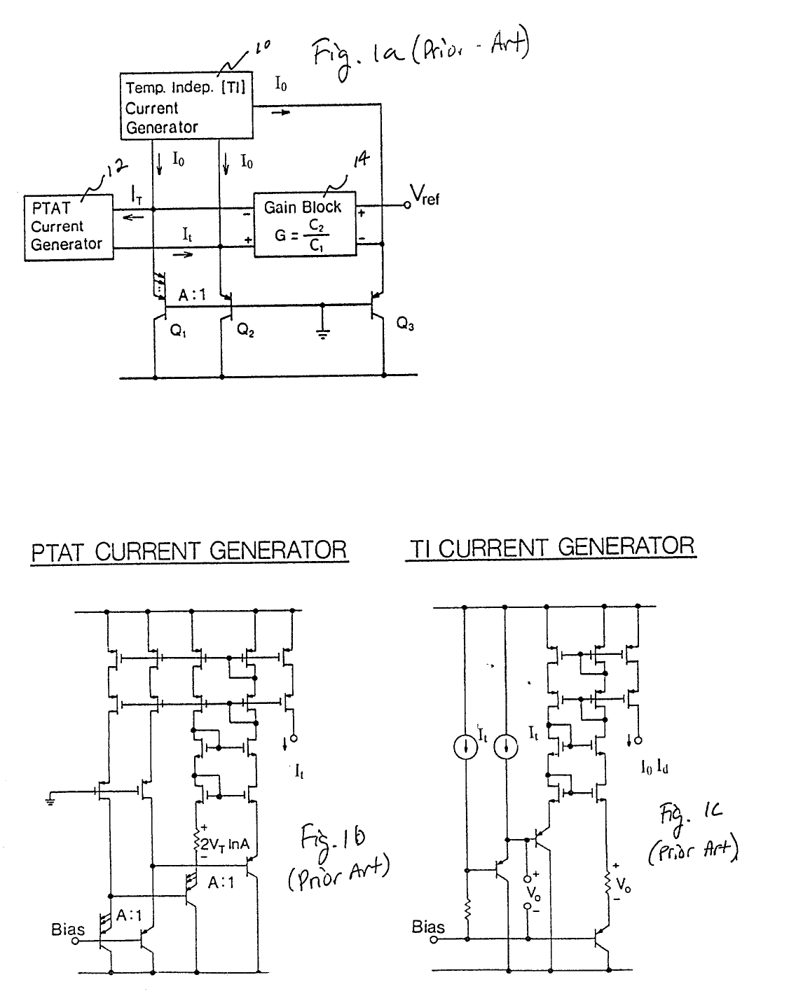

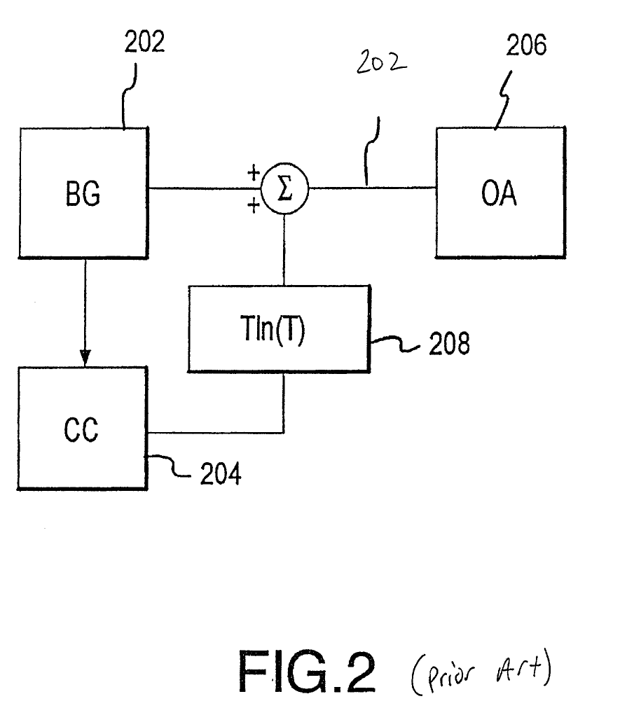

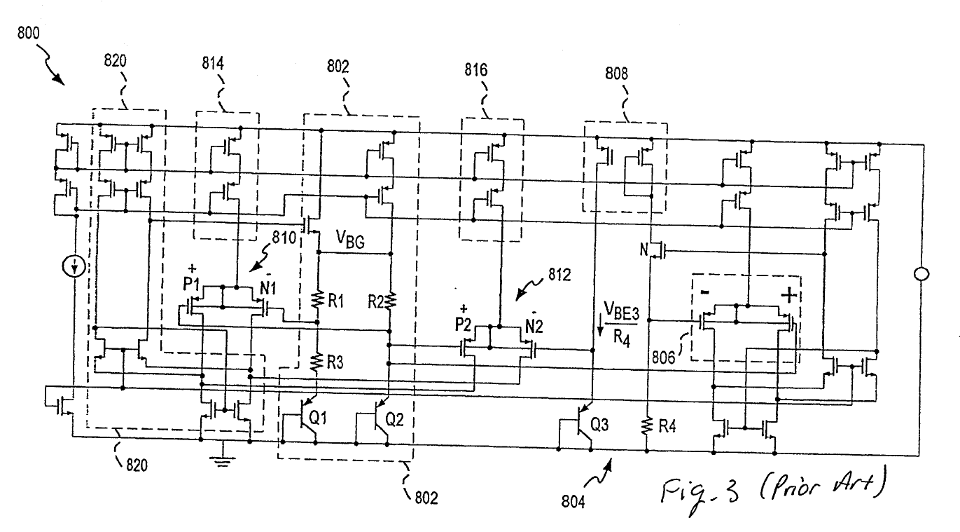

### DETAILED DESCRIPTION

The present invention is directed to a method or bandgap reference voltage cell (circuit) that produces an output reference voltage having first-order and second-order (curvature) temperature coefficient compensation. The compensation or correction circuitry is integrated within the bandgap cell itself, providing for a simple and efficient method and circuit.

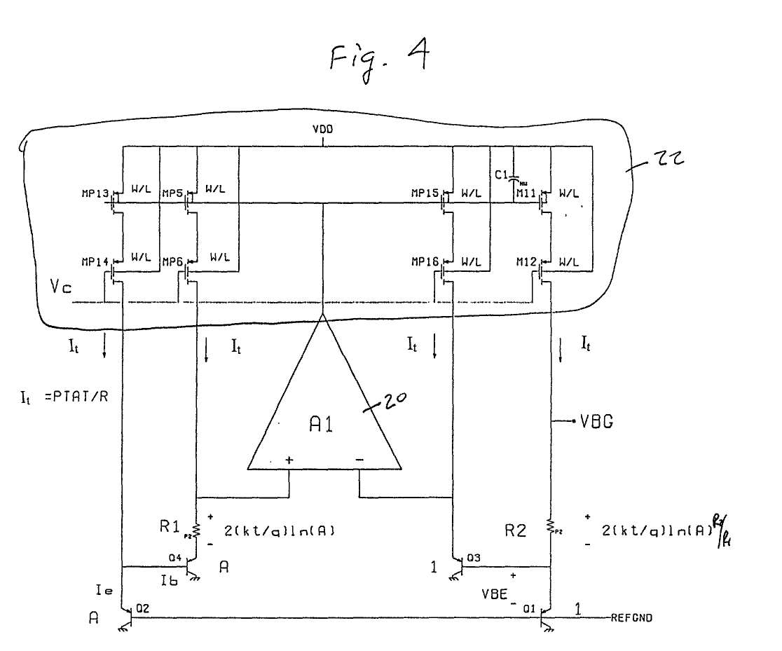

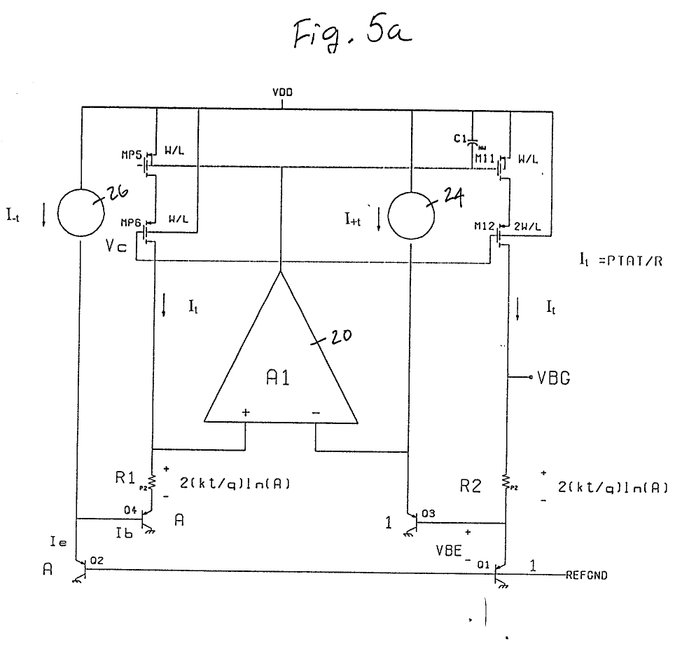

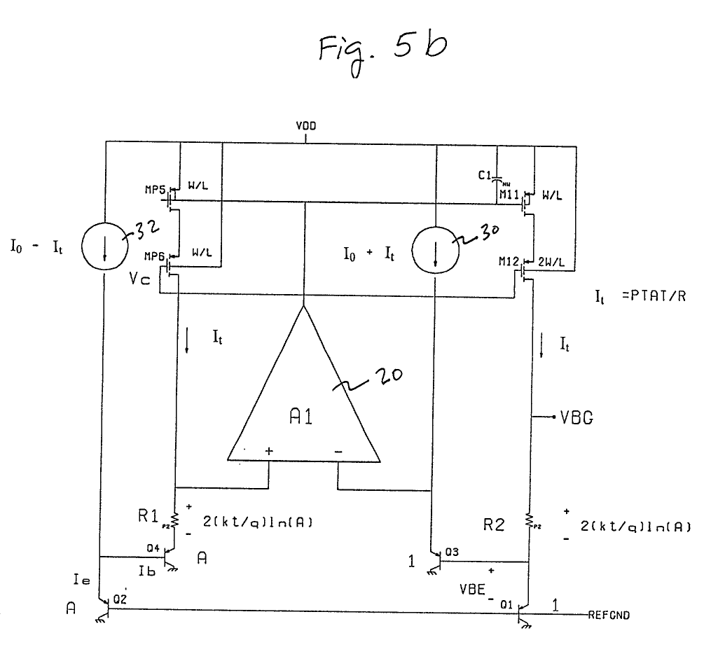

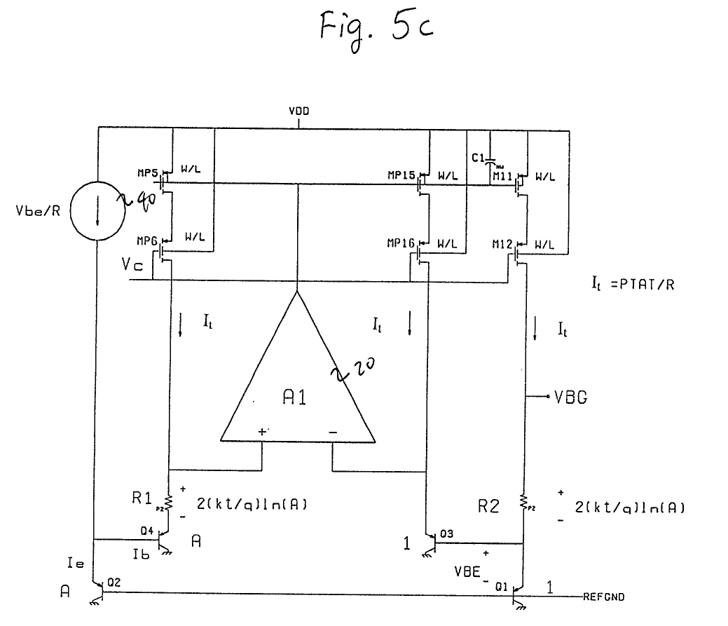

FIG. 4 is a schematic diagram of a stacked bandgap cell. The cell includes amplifier 20, current mirror 22, transistors Q1-Q4, and resistors R1 and R2. Amplifier 20 has a gain of A1. As shown, temperature dependent current Iₜ, produced in multiple copies by current mirror 22, flows through each of transistors Q1-Q4. The ΔV_{be} of transistors Q1-Q4 is placed across resistor R1, with amplifier 20. The ratio of the resistances of R2 to R1 provides the gain. The use of four transistors Q1-Q4 provides twice the ΔV_{be} of that of a circuit including just two transistors. Thus, there is need for less gain. As the ΔV_{be} is added to the V_{be} of transistor Q1 (also caused by the flow of current Iₜ across resistor R2), output voltage VBG is produced.

One embodiment of the present invention is adding second-order temperature coefficient or curvature correction to the bandgap cell of FIG. 4, within the bandgap cell itself. This is done by inducing a second-order curvature in ΔV_{be} which eliminates that of V_{be}. One method for inducing the second-order curvature in ΔV_{be} is by feeding two of the four transistors in the stacked cell currents with different temperature coefficients. However, it should be appreciated that the currents flowing through resistors R1 and R2 have to remain temperature-dependent (PTAT) in order to achieve the first-order correction.

FIG. 5a is a schematic diagram of a stacked bandgap cell, like that of FIG. 4, but with the second-order curvature correction in the output voltage VBG. As shown, the cell includes amplifier 20, positive temperature coefficient current generator 24 and negative temperature coefficient current generator 26. Current generator 24 produces temperature-dependent current I₊ₜ, having a positive temperature coefficient. Current generator 26 produces temperature-dependent current I₋ₜ, having a negative temperature coefficient. It should be appreciated that current I₋ₜ need not have a negative temperature coefficient, just that the temperature coefficient of I₊ₜ be more positive than that of I₋ₜ. As stated, the currents in transistors Q1 and Q4 must be temperature-dependent in order to produce the first-order temperature correction. There is, however, more freedom to choose temperature coefficients of the currents flowing through transistors Q2 and Q3, so as to produce the desired second-order correction. When the current flowing in transistor Q2 has a more negative temperature coefficient than that flowing in resistor Q3, a non-linearity will result in the ΔV_{be}, which will appear in the voltage across resistor R2. This non-linearity will offset the non-linearity in the base emitter voltage V_{be} of transistor Q1. With appropriate selection of parameters, the two non-linearities can be made to be equal and opposite such that they will eliminate one another, thereby producing an output voltage VBG, which will be first- and second-order invariant with temperature.

FIG. 5b is a schematic diagram of an alternate embodiment stacked bandgap cell with second-order curvature correction. As shown, the cell includes amplifier 20 and current sources 30 and 32. By contrast with the cell shown in FIG. 5a, the cell shown in FIG. 5b uses both temperature-dependent currents, Iₜ, and temperature-independent currents, I₀. I₀ is a temperature-independent constant current. Current source 30 produces I₀ plus Iₜ, while current source 32 products I₀ minus Iₜ. The use of temperature-dependent current Iₜ is convenient because it already is used in the bandgap cell for first-order correction. It otherwise operates similarly to the cell shown and described in FIG. 5a.

FIG. 5c is a schematic diagram of even a further alternate embodiment stacked bandgap cell having second-order curvature correction. The cell of FIG. 5c includes amplifier 20 and current generator 40. The bandgap cell shown in FIG. 5c operates similarly to that of FIG. 5a and FIG. 5b, except that the current produced flowing through transistor Q2 is produced as V_{be}/R, i.e., the V_{be} of a transistor (not shown) divided by a resistor (also not shown).

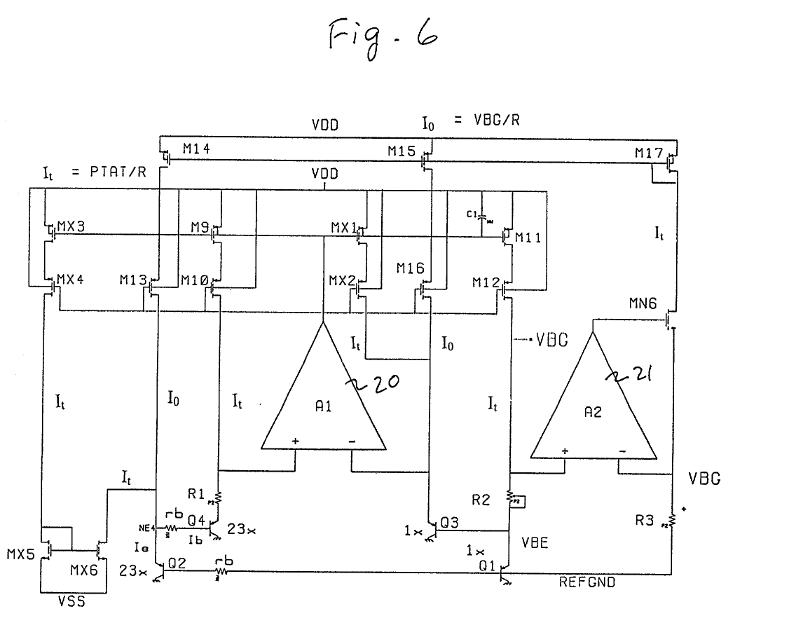

FIG. 6 is a schematic diagram of one embodiment of a second-order curvature corrected stacked bandgap cell according to the invention. The cell includes amplifiers 20 and 21, having respective gains of A1 and A2. A basic stacked bandgap cell includes transistors Q1-Q4, amplifier 20 and transistors M9-M16. Temperature-compensated output voltage VBG is the base emitter voltage V_{be} of resistor Q1 added to the voltage across resistor R2. That voltage, across resistor R2, is a scaled copy of the voltage provided across resistor R1. That voltage is predominantly temperature-dependent, but has a second-order non-linearity that cancels the second-order non-linearity in the base emitter voltage V_{be} of transistor Q1. Making the quiescent currents of transistors Q2 and Q3 have significantly different temperature coefficients produces that non-linearity.

In the embodiment shown in FIG. 6, the output voltage VBG is used to generate the temperature-independent constant current I₀. Amplifier 21, having a gain of A2, provides output voltage VBG across resistor R3, creating a constant current VBG/R3 equaling I₀ flowing through resistor R3. This constant current, copied by current mirrors comprised of elements M13-M17, is supplied to transistors Q2 and Q3. The temperature-dependent currents Iₜ are produced in the bandgap cell itself and flow through transistors Q4 and Q1. In the embodiment shown in FIG. 6, the current in Q3 actually is the sum Iₜ+I₀, and the current flowing in Q2 is the difference, I₀-Iₜ. Thus, the temperature coefficient of current flowing through Q3 is more positive than that of current flowing through Q2, producing the non-linearity which will cancel that of the V_{be}. M17 is a transistor, arranged as a diode, that, with M14 and M15, acts as a current mirror. It copies current I₀ in transistors M14 and M15. Transistors MX1 and MX2 produce temperature-dependent current Iₜ which is equal to PTAT/R. This is added to temperature-independent current I0 before flowing through transistor Q3. Transistors MX5 and MX6, acting as a negative current mirror, produce current −Iₜ which is added to current to, such that current I₀-Iₜ flows through transistor Q2.

The cell shown in FIG. 6 produces a stable, temperature-independent voltage VBG. In silicon-based technologies, this voltage may be on the order of approximately 1.2 volts. In many applications, however, a larger temperature stabilized voltage is desirable.

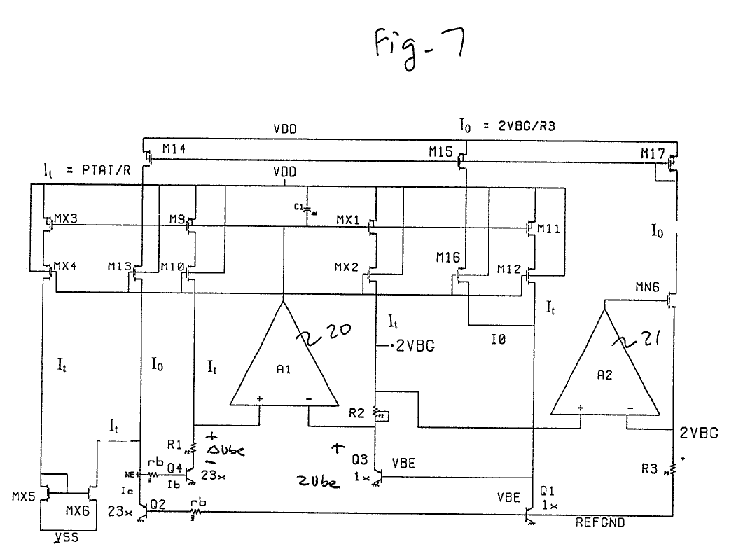

FIG. 7 is a schematic diagram of a bandgap cell that produces approximately 2VBG, or approximately 2.4 volts. In the embodiment shown in FIG. 7, the voltage across resistor R2 is doubled and added to two base emitter voltages, or 2V_{be}, to produce twice the stable output voltage, or 2VBG. Curvature correction is accomplished, as described with respect to FIG. 6, except that transistor Q1, as opposed to transistor Q3, receives the temperature-dependent current plus a constant current, or Iₜ plus I₀.

As stated, twice the base emitter voltage is utilized, and is produced by adding the base emitter voltages of transistors Q1 and Q3. Also, in comparison to FIG. 6, the gain R2/R1 is twice as great. In addition, unlike FIG. 6, resistor R2 is moved to be in series with transistor Q3. Also, Iₜ now flows through transistor Q3 and Iₜ+I₀ now flows through transistor Q1.

Having thus described at least one illustrative embodiment of the invention, various alterations, modifications and improvements will readily occur to those skilled in the art. Such alterations, modifications and improvements are intended to be within the spirit and scope of the invention. Accordingly, the foregoing description is by way of example only and is not intended as limiting. The invention is limited only as defined in the following claims and the equivalents thereto.

What is claimed is:

1. A method of producing a temperature-compensated reference voltage comprising steps of:
providing a stacked bandgap cell including at least four bipolar elements; and
biasing at least a first of the four elements with a first quiescent current and biasing at least a second of the four elements with a second quiescent current;
wherein a temperature coefficient of the first quiescent current is different from a temperature coefficient of the second quiescent current.

2. The method as claimed in claim 1 wherein each of the at least four elements is a diode.

3. The method as claimed in claim 1 wherein each of the at least four elements is a transistor.

4. The method as claimed in claim 1 wherein the temperature coefficient of the first quiescent current is positive and the temperature coefficient of the second quiescent current is negative.

5. The method as claimed in claim 1 wherein the first quiescent current is equal to a temperature-independent current plus a temperature-dependent current, and the second quiescent current is equal to the temperature-independent current minus the temperature-dependent current.

6. The method as claimed in claim 5 further including a step of using an output voltage of the bandgap cell to produce the temperature-independent current.

7. The method as claimed in claim 6 wherein the a step of using includes providing the output voltage of the bandgap cell across a resistor to produce the temperature-independent current.

8. A bandgap cell that produces a first-order and a second-order temperature-compensated reference output voltage comprising:
at least first and second bipolar elements;
wherein the first bipolar element is biased with a first quiescent current and the second bipolar element is biased with a second quiescent current, a temperature coefficient of the first quiescent current being different from a temperature coefficient of the second quiescent current.

9. The bandgap cell of claim 8 wherein the at least first and second bipolar elements includes at least four bipolar elements.

10. The bandgap cell of claim 8 wherein each of the at least first and second bipolar elements is a transistor.

11. The bandgap cell of claim 8 wherein each of the at least first and second bipolar elements is a diode.

12. The bandgap cell of claim 8 wherein the temperature coefficient of the first quiescent current is positive and the temperature coefficient of the second is negative.

13. The bandgap cell of claim 8 wherein the first quiescent current is equal to a temperature-independent current plus a temperature-dependent current and the second quiescent current is equal to the temperature-independent current minus the temperature-dependent current.

14. The bandgap cell of claim 13 wherein the output voltage of the bandgap cell is used to produce the temperature-independent current.

15. The bandgap cell of claim 14 wherein the output voltage is placed across a resistor to produce the temperature-independent current.

16. The bandgap cell of claim 13 further including a current mirror to produce at least one additional copy of the temperature-dependent current.

17. The bandgap cell of claim 8 further including a gain amplifier coupled to at least the first and second bipolar elements.

18. A method for providing a temperature-compensated bandgap reference voltage comprising:
providing a bandgap reference voltage cell including at least two bipolar elements; and
realizing first and second order temperature compensation to the reference voltage within the bandgap cell.

19. The method as claimed in claim 18 further including the step of maintaining the bandgap reference voltage at approximately half of a full-scale reference voltage.

20. The method as claimed in claim 19 wherein the approximately half of the full-scale reference voltage is within the range of 2.3 volts to 2.7 volts.
